(19) United States
(12) Patent Application Publication
(10) Pub. No.: US 2015/0352925 A1
(43) Pub. Date: Dec. 10, 2015

(54) METHOD AND SYSTEM FOR CONTROLLING OPERATION OF CONDENSER AND EVAPORATOR FANS

(71) Applicant: THERMO KING CORPORATION, Minneapolis, MN (US)

(72) Inventors: Omosola Waidi OLYLEYE, Brooklyn Park, MN (US); Alan D. GUSTAFSON, Eden Prairie, MN (US)

(21) Appl. No.: 14/758,445

(22) PCT Filed: Dec. 27, 2013
(86) PCT No.: PCT/US2013/078015

§ 371 Date: Jun. 29, 2015

Related U.S. Application Data
(60) Provisional application No. 61/746,656, filed on Dec. 28, 2012.

(51) Int. Cl. B60H 1/32; B60P 3/20; B60H 1/00

(52) U.S. Cl. CPC B60H 1/3211; B60H 1/00764; B60H 1/00878; B60P 3/20; B60H 1/3232; B60H 1/3226

(57) ABSTRACT

Methods and systems for controlling the operation of the condenser and evaporator fans in a transport refrigeration system are described. The methods and systems described herein generally control dynamically a plurality of system fans needed to meet a plurality of system airflow objectives, where the objectives may sometimes be conflicting. The methods and systems described herein can be used to strike an optimal balance between system performance, protection, safety and regulatory requirements. In some embodiments, the systems and methods described herein provides for controlling the operation of at least two condenser fans based on the difference between a coil temperature (e.g., discharge pressure temperature saturation) and an ambient temperature and controlling the operation of at least one evaporation fan based on an air temperature differential.

The embodiments disclosed herein relate generally to a transport refrigeration system (TRS). More particularly, the embodiments relate to methods and systems for controlling the operation of the condenser and evaporator fans in a TRS.

### BACKGROUND

Existing transport refrigeration systems are used to cool containers, trailers, railcars or other transport units. A temperature controlled transport unit (typically referred to as a “refrigerated transport unit”) is commonly used to transport perishable items such as produce and meat products. In such a case, a TRS can be used to condition the air inside a cargo space of the transport unit, thereby maintaining desired temperature and humidity settings during transportation or storage. Typically, a transport refrigeration unit (“TRU”) is attached to the transport unit to facilitate a heat exchange between the air inside the cargo space and the air outside of the transport unit.

### SUMMARY

The embodiments described herein are directed to a TRS. In particular, the embodiments described herein are directed to methods and systems for controlling the operation of the condenser and evaporator fans in the TRS.

The methods and systems described herein generally control dynamically a plurality of system fans needed to meet a plurality of system requirements which may sometimes conflict. The methods and systems described herein can be used to strike an optimal balance between system performance, protection, safety and regulatory requirements.

Generally, the methods and systems described herein can achieve optimal performance and system protection with precise control of airflow across a set of one or more evaporators and airflow across a set of two or more condensers, while meeting regulatory requirements (e.g., mandated Environmental Protection Agency (EPA) emissions limit requirements) with optimized intercooler airflow requirements. System protection can be achieved by maintaining engine operation within a defined set of engine operation parameters. Such operating parameters can include, for example, not exceeding engine power capacity per time slice, providing adequate engine cooling needed to meet performance and durability requirements, and not exceeding generator ability. The methods and systems described herein can lead to a reduced initial cost of the system and total cost of ownership of the system. These are achieved through the use of fewer hardware components such as fans (reduced complexity), less weight of the system, and less costs during operation, e.g., due to fuel savings and increased system performance.

In some embodiments, the systems and methods described herein provides for controlling the operation of at least two condenser fans based on the difference between a coil temperature (e.g., discharge pressure temperature saturation) and an ambient temperature and controlling the operation of at least one evaporator fan based on an air temperature differential.

In one embodiment of the process of controlling the operation of the condenser and the evaporator fans, a plurality of parameters are determined. In one example, the parameters include a discharge pressure temperature saturation (DPT_{SAT}), a minimum discharge pressure (DP_{MIN}), an ambient temperature (AT), an engine coolant temperature (ECT), an engine intercooler temperature (EICT), an engine cooling fan request (ECFR), an engine intercooler fan request (EIFR), and a box temperature (BT). Then, a determination is made as to whether there is a conflict between the determined parameters and a set of predetermined operating conditions.

If there is a conflict, then the condenser and the evaporator fans operate based on the set of predetermined operating conditions. If there is no conflict, then the condenser and the evaporator fans operate in a certain state of operation, e.g., on state, off state, high speed, low speed, or continuously varying speed, based on certain predetermined conditions.

In one example, when the difference between the determined DPT_{SAT} and the AT (T1) is greater than a first predetermined value, a first condenser fan is turned on. When a second predetermined value is greater than second predetermined value, a second condenser fan is turned on. When the determined ECT is greater than a third predetermined value, the first condenser fan and/or the second condenser fan are turned on.

In another example, when the determined ECT is less than a fifth predetermined value, the first condenser fan is turned off. When the determined ECT is less than the fifth predetermined value, the second condenser is turned off.

In yet another example, when the difference between a box temperature and a target temperature (T2) is greater than a seventh predetermined value, the evaporator fan operates at high speed. When T2 is less than an eight predetermined value, the evaporator fan operates at low speed.

In some embodiments, the condenser fans are single speed fans and the evaporator fan(s) is a dual speed fan. In other embodiments, the condenser fans and the evaporator fan(s) are variable speed condenser fans.

Other aspects of the invention will become apparent by consideration of the detailed description and accompanying drawings.

### BRIEF DESCRIPTION OF THE DRAWINGS

Referring now to the drawings in which like reference numbers represent corresponding parts throughout.

FIG. 1A illustrates a side view of a reefer attached to a tractor, according to one embodiment.

FIG. 1B illustrates a back view of the refrigerated transport unit shown in FIG. 1A, according to one embodiment.

FIG. 2A illustrates a schematic cross sectional side view of a TRU, according to one embodiment.

FIG. 2B illustrates a top view of the TRU shown in FIG. 2A, according to one embodiment.

FIG. 2C illustrates a back view of the TRU shown in FIG. 2A, according to one embodiment.

FIG. 3 illustrates a block diagram of a TRU, according to one embodiment.

FIGS. 4A-4C illustrate block diagrams of different configurations of the components of the TRU, according to some embodiments.

FIG. 5 illustrates another block diagram of a TRU, according to one embodiment.

FIG. 6 illustrates a summary of the inputs and outputs of a TRS Controller, according one embodiment.

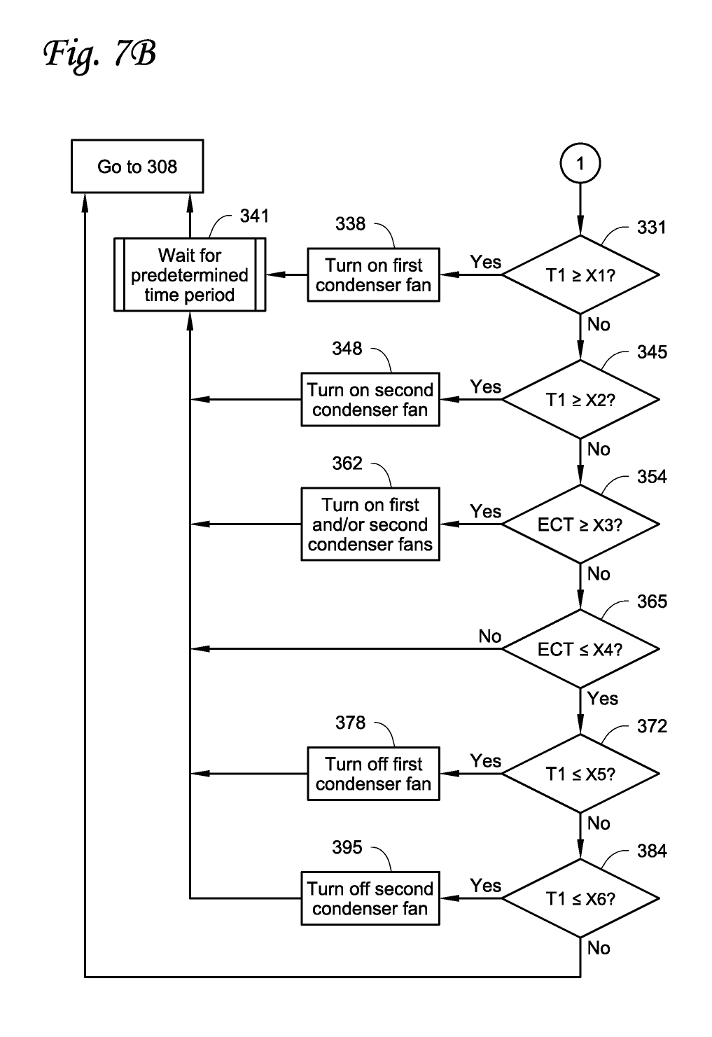

FIGS. 7A-7C are flowcharts for the process of controlling the operation of the condenser and evaporator fans in the TRS, according to one embodiment.

FIG. 8 is a flowchart for the process of providing controller instructions to drive single contactors at points 1-6 shown in FIG. 5, according to one embodiment.

### DETAILED DESCRIPTION

The embodiments described herein are directed to a transport refrigeration system (TRS). More particularly, the embodiments relate to methods and systems for controlling the operation of the condenser and evaporator fans in a TRS.

References are made to the accompanying drawings that form a part hereof, and in which is shown by way of illustration of the embodiments in which the methods and systems described herein may be practiced. The term “refrigerated transport unit” generally refers to, for example, a conditioned trailer, container, railcars or other type of transport unit, etc. The term “transport refrigeration system” or “TRS” refers to a refrigeration system for controlling the refrigeration of a conditioned interior space of the refrigerated transport unit. The term “TRS controller” refers to an electronic device that is configured to manage, command, direct and regulate the behavior of one or more TRS refrigeration components of a refrigeration circuit (e.g., an evaporator, a condenser, a compressor, an expansion valve (EXV), etc.), a genset, etc.

It will be appreciated that the embodiments described herein may be used in any suitable temperature controlled apparatus such as a ship board container, an air cargo cabin, an over the road truck cabin, etc. The TRS may be a vapor-compressor type refrigeration system, or any other suitable refrigeration system that can use refrigerant, cold plate technology, etc.

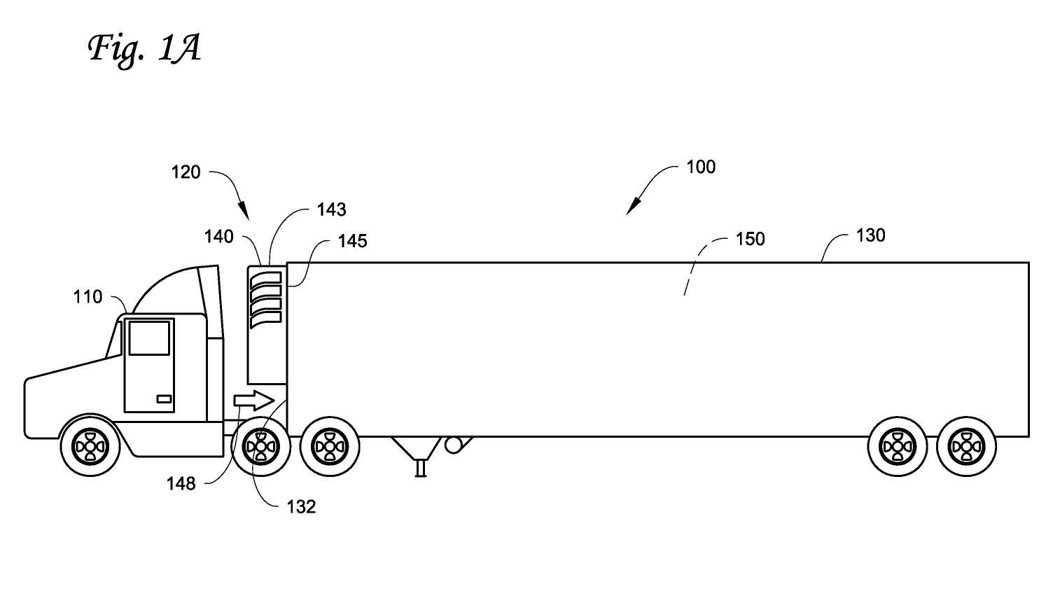

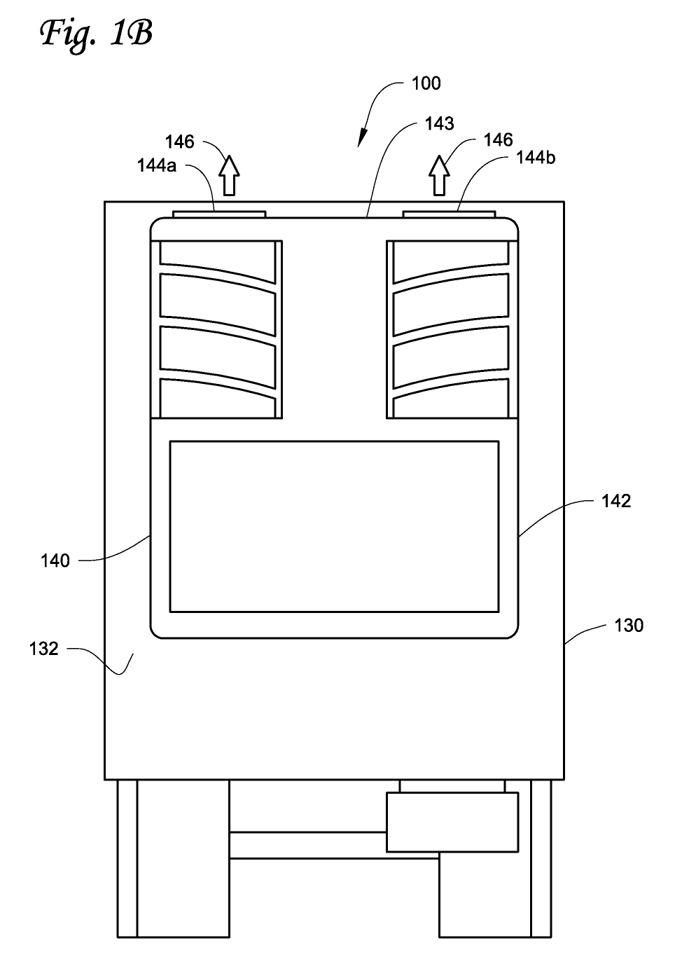

FIGS. 1A and 1B illustrate different views of a refrigerated transport unit 100 that is towed by a tractor 110, with which the embodiments as described herein can be practiced. As shown in FIG. 1A, the refrigerated transport unit unit 100 includes a TRS 120 and a transport unit 130. The TRS 120 is configured to control a temperature of an internal space 150 of the transport unit 130. In particular, the TRS 120 is configured to transfer heat between an internal space 150 and the outside environment. In some embodiments, the TRS 120 is a multi-zone system in which different zones or areas of the internal space 150 are controlled to meet different refrigeration requirements based on the cargo stored in the particular zone. The TRS 120 includes a transport refrigeration unit (TRU) 140.

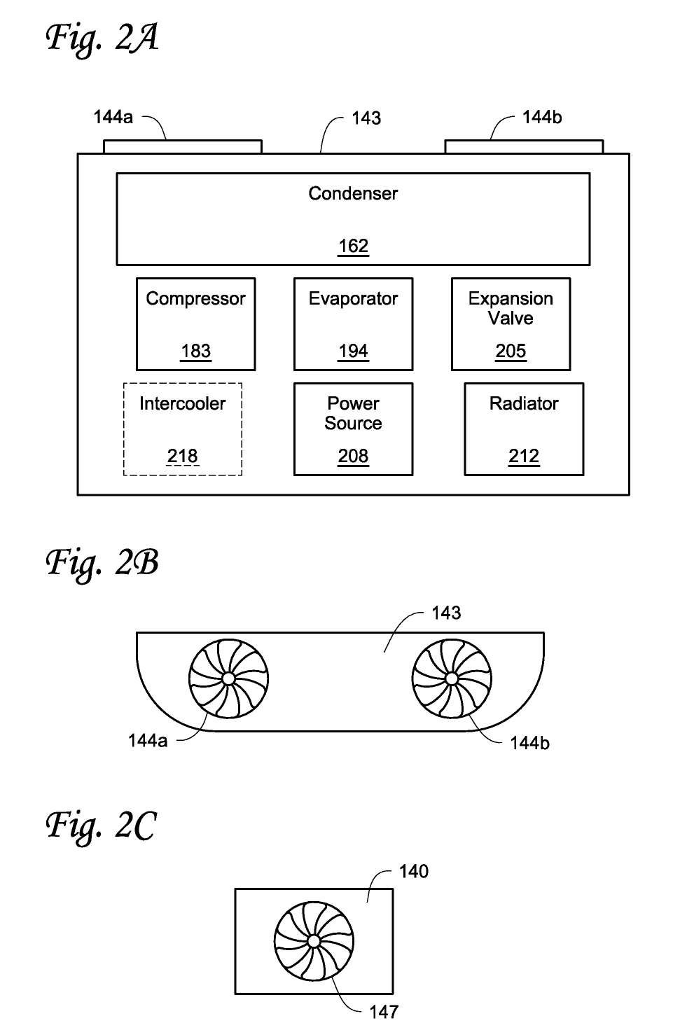

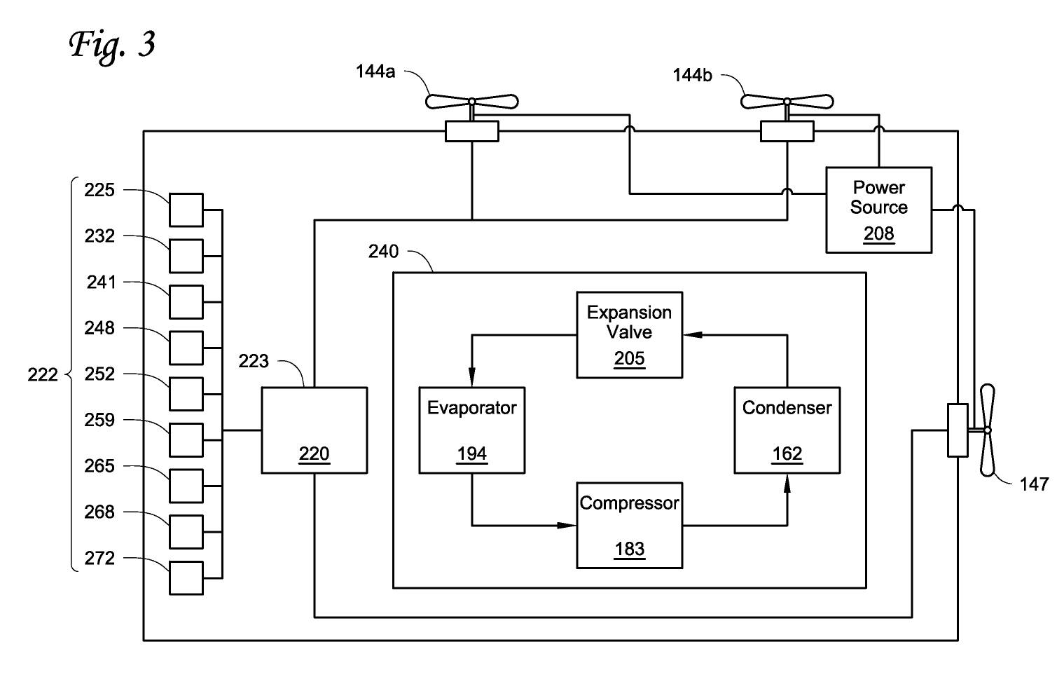

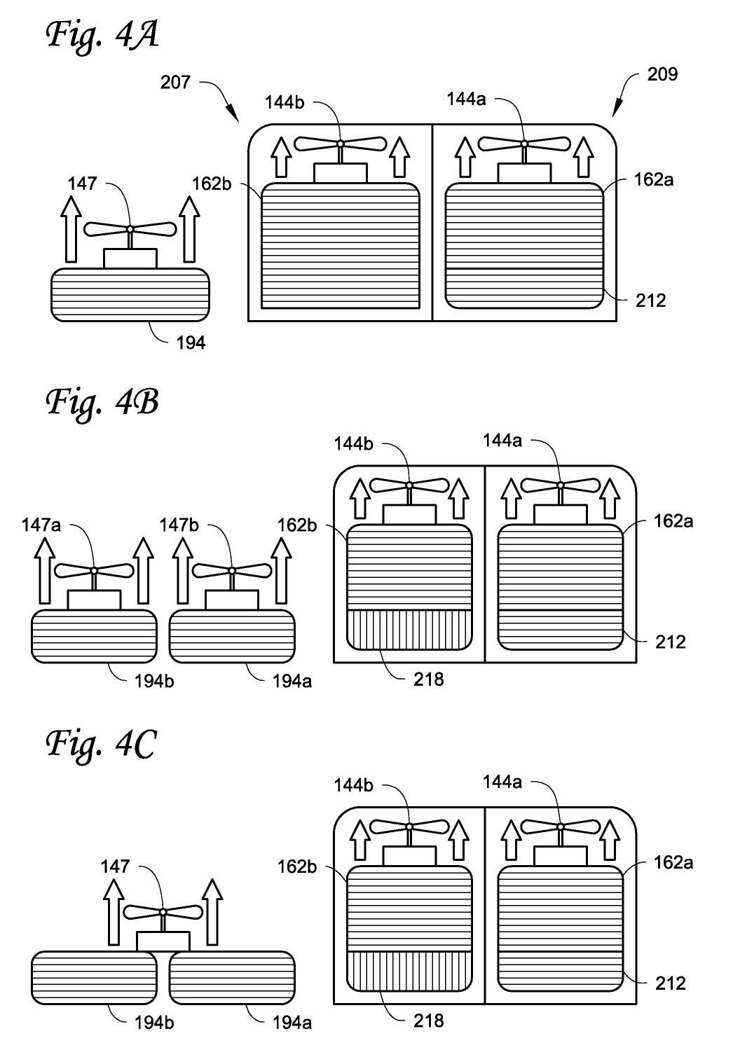

As shown in FIG. 1B, the TRU 140 is provided at the front wall 132 of the transport unit 130 and includes a housing 142. As shown in FIGS. 1B, 2A and 2B, the TRU 140 further includes two condenser fans 144a, 144b at a top end 143 of the TRU 140.

Each of the two condenser fans 144a, 144b is configured to discharge air out of the TRU 140 in a vertically upward direction as shown by arrows 146. The condenser fans 144a, 144b shown in FIG. 1B are axial fans. While the TRU 140 is illustrated as including two condenser fans 144a, 144b, in other embodiments, the TRU 140 can be designed to include more than two condenser fans based on the desired configuration.

In one embodiment, the condenser fans 144a, 144b are axial fans. In other embodiments, the condenser fans 144a, 144b can be any type of that is suitable for moving air in the TRS 120, and can include, but is not limited to vane axial fans, radial fans, etc.

In some embodiments, the speed (e.g., rpm) of the condenser fans 144a, 144b can be frequency controlled based on a speed of an engine of a TRS genset. For example, in one embodiment, the condenser fans 144a, 144b can operate at ˜2650 rpm when the engine is operating at ˜2050 rpm and can operate at ˜1620 rpm when the engine is operating at ˜1250 rpm. It is to be realized that in other embodiments, the fan motor speed can vary as desired.

In other embodiments, the condenser fans 144a, 144b can be two-speed condenser fans that are configured to be electronically controlled by the TRS Controller 220 to operate at a high speed and a low speed. In these embodiments, for example, the high speed of the condenser fans 144a, 144b can be ˜2650 rpm and the low speed of the condenser fans 144a, 144b can be ˜1620 rpm. It is to be realized that in other embodiments, the engine speed and the fan motor speed can vary as desired.

In yet some other embodiments, the condenser fans 144a, 144b are variable speed condenser fans, whereby the speed of the condenser fans 144a, 144b can be electronically controlled by the TRS Controller 220.

Referring to FIG. 1A and FIG. 2C, the TRU 140 also includes an evaporator fan 147 at a backend 145 of the TRU 140. The evaporator fan 147 is configured to discharge air out of the TRU 140 in generally a horizontal lateral direction into the transport unit 130 as shown by the arrow 148 in FIG. 1A. While the TRU 140 is illustrated as including one evaporator fan 147, in other embodiments, the TRU 140 can be designed to include more than one evaporator fan based on the desired configuration.

In some embodiments, the evaporator fan 147 can be a multi-speed fan that is configured to operate at a continuously varying speed. In some examples, the evaporator fan 147 is a two speed evaporator fan that operates at a high speed or a low speed. In these embodiments, the high speed of the evaporator fan 147 can be ˜1750 rpm. The low speed of the evaporator fan 147 can be ˜1400 rpm.

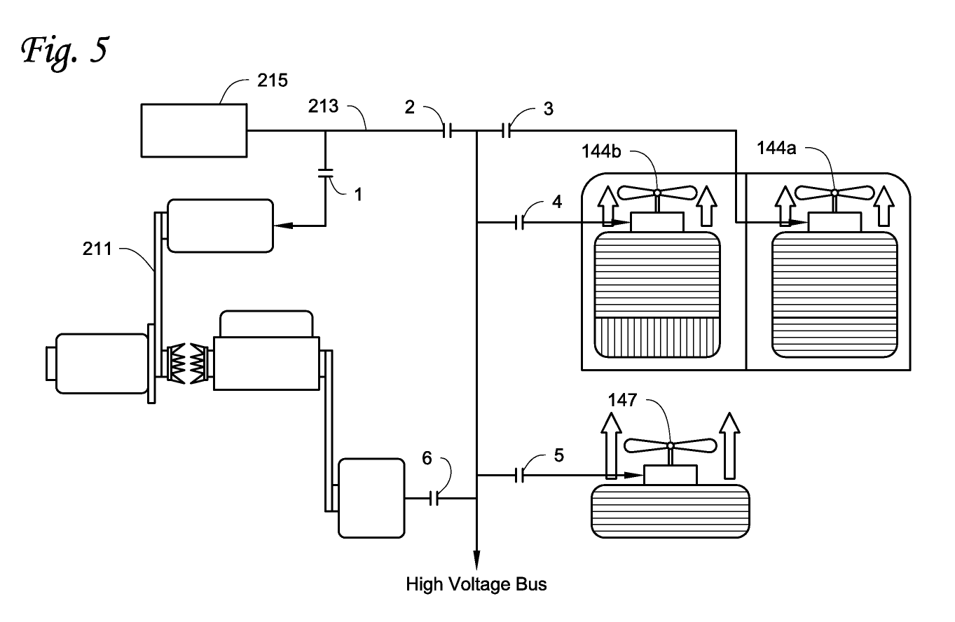

The TRU 140 is configured to be in communication with the internal space 150 and is also configured to control the temperature in the internal space 150. The components within the TRU 140 are described below with reference to FIG. 2A and FIG. 3. FIG. 2A shows a schematic cross sectional view of the TRU 140 showing the components within the TRU 140. FIG. 3 illustrates a block diagram of components within the TRU 140.

Generally, as illustrated in FIG. 2A, the TRU 140 can include, in addition to the condenser fans 144a, 144b and evaporator fan 147, a power source 208, an engine radiator 212, optionally an intercooler 218, a condenser 162, a compressor 183, an evaporator 194 and an expansion valve 205 as generally known in the art. In some examples, the power source 208 can include an engine. The condenser 162 is in airflow communication with the condenser fans 144a, 144b, and the evaporator 194 is in airflow communication with the evaporator fan 147.

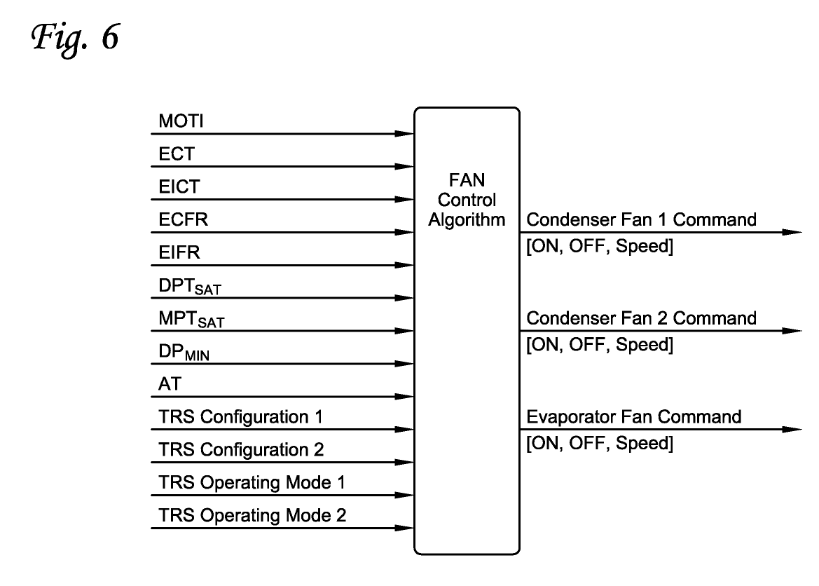

Examples of different configurations of the condenser fans 144a, 144b, the evaporator fan 147, the radiator 212 and/or the intercooler 218 will now be described with reference to FIGS. 4A to 4C. In some examples, the TRU 140 is configured so that the condenser fan 144a is on a road side 209 of the TRU 140 and the condenser fan 144b is on a curb side 207 of the TRU 140. In one example as shown in FIG. 4A, a first condenser coil 162a and the engine radiator 212 are provided on the road side 209, and a second condenser coil 162b is provided on the curb side 207. In this instance, the air flow on the road side 209 is through the first condenser coil 162a and the engine radiator 212 so that hot air blows out of the TRU 140 via the condenser fan 144a. The air flow on the curb side 207 is through the second condenser coil 162b so that hot air blows out of the TRU 140 via the condenser fan 144b. The air that flows through the evaporator 194 is blown into the internal space 150 as cold air via the evaporator fan 147.

In another example as shown in FIG. 4B, the first condenser coil 162a and the engine radiator 212 are provided on the road side 209, and the second condenser coil 162b and the intercooler 218 are provided on the curb side 207. In this instance, the air flow on the road side 209 is through the first condenser coil 162a and the engine radiator 212 so that hot air blows out of the TRU 140 via the condenser fan 144a. The air flow on the curb side 207 is through the second condenser coil 16 and the intercooler 218 so that hot air blows out of the TRU 140 via the condenser fan 144b. In this example, the TRU 140 includes two evaporator fans 147a, 147b, where the air flows through a first evaporator coil 194a and a second evaporator coil 194b so that cold air is blown into the internal space 150 via the two evaporator fans 147a, 147b.

FIG. 4C illustrates yet another example configuration of some of the components of the TRU 140. This example is the same as that of shown in FIG. 4B except that the TRU 140 includes one evaporator fan 147, where the air flows through the first evaporator coil 194a and the second evaporator coil 194b so that cold air is blown into the internal space 150 via the evaporator fan 147.

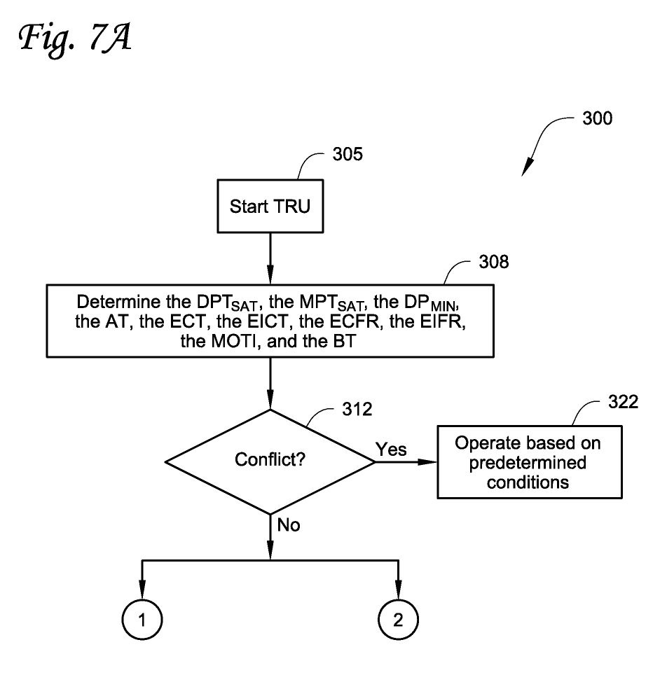

With reference to FIGS. 2A and 3, the power source 208 can be any power source that is suitable for use with the TRS 120. In one example, the power source 208 is a generator set 211 and/or a 3 phase utility power 215 as shown in FIG. 5. The generator set 211 and/or a 3 phase utility power 215 can be used to power the condenser fans 144a, 144b and the evaporator fan 147 via a circuit 213. The circuit 213 includes contact points 1, 2, 3, 4, 5 and 6, and each of the contact points can be controlled via a TRS controller (details of the TRS controller will be discussed in detail below) to make or break a power connection to a high voltage bus. In the example shown in FIG. 5, six contact points are shown. It is to be realized however, that the contact points included in the circuit 213 can be any number of contact(s) that is(are) suitable for operating and controlling the TRS 120.

With reference to FIG. 3, the TRU 140 further includes a plurality of sensors 222. The plurality of sensors 222 include a sensor 225 to detect a discharge pressure temperature saturation (DPT_{SAT}), a sensor 232 to detect a minimum pressure temperature saturation (MPTSAT), a sensor 241 to detect a minimum discharge pressure (DP_{MIN}), a sensor 248 to detect an ambient temperature (AT), a sensor 252 to detect an engine coolant temperature (ECT), a sensor 259 to detect an engine intercooler temperature (EICT), a sensor 265 to detect an engine cooling fan request (ECFR), a sensor 268 to detect an engine intercooler fan request (EIFR), and a sensor 272 to detect a box temperature (BT).

With reference to FIG. 3, the TRU 140 further includes a TRS Controller 220. The TRS Controller 220 generally can include a processor (not shown), a memory (not shown), a clock (not shown) and an input/output (I/O) interface 223 and can be configured to receive data as input from various components within the TRS 120, and send command signals as output to various components within the TRS 120.

Generally, the TRS Controller 220 is configured to control a refrigerant circuit 240 that includes the condenser 162, the expansion valve 205, the evaporator 194 and the compressor 183. In one example, the TRS Controller 220 controls the operating states of each of the condenser fans 144a, 144b and the evaporator fan 147. In another example, the TRS Controller 220 controls the refrigeration circuit 240 to obtain various operating conditions (e.g., temperature, humidity, etc.) of the internal space 150 as is generally understood in the art. The refrigeration circuit 240 regulates various operating conditions (e.g., temperature, humidity, etc.) of the internal space 150 based on instructions received from the TRS Controller 220.

In one example, during operation, the TRS Controller 220 receives information from the plurality of sensors 222 through the I/O interface 223 as inputs, processes the received information using the processor based on an algorithm stored in the memory, and then send command signals as outputs, to the condenser fans 144a, 144b and the evaporator fan 147. A summary of the inputs and outputs are illustrated in FIG. 4.

Details of the inputs that are received by the TRS Controller 220 will now be described. The inputs that are received by the TRS Controller 220 include data of parameters that are typically received when operating the TRS 120, such as a discharge pressure temperature saturation (DPT_{SAT}), a minimum pressure temperature saturation (MPTSAT), a minimum discharge pressure (DP_{MIN}), an ambient temperature (AT); an engine coolant temperature (ECT), an engine intercooler temperature (EICT), an engine cooling fan request (ECFR), an engine intercooler fan request (EIFR) and a box temperature (BT).

The inputs received by the TRS Controller 220 further can include data regarding certain TRS configurations and certain TRS operating modes. In one example, data regarding the first TRS configuration can be whether the TRS 120 is running on power generated by an engine (e.g., diesel engine) of a TRS generator set (genset) only, or by power generated by the engine of the TRS genset and power from an electric power source (e.g., shore power). Data regarding the second TRS configuration can be whether the TRS 120 is configured with a single zone temperature zone or multiple zone temperature. In one example, multiple zone temperature units include a dual evaporator or a single evaporator. In the case where a dual evaporator is included, the two zones can be separated by a wall in the trailer refrigerated with a single motor or dual motors.

Data regarding the first TRS operating mode can be whether the TRS is in cool mode, heat mode or defrost mode. Data regarding the second TRS operating mode can be whether the TRS is in electric mode or engine mode.

In some instances, the TRS is architecturally constructed to run on power generated by an engine (e.g., diesel engine) of a TRS generator set (genset) only, and/or power from an electric power source (e.g., shore power). In this instance, the TRS controller 220 receives input regarding the first TRS configuration. In some other instances, the TRS is architecturally constructed to run on power generated by an engine (e.g., diesel engine) of a TRS generator set (genset) only or power from an electric power source (e.g., shore power) only. In this instance, the TRS controller 220 receives input regarding the second TRS operating mode.

Details of the command signals for the desired state of the condenser fans 144a, 144b and the evaporator fan 147 will now be described. The command signals for the desired state of the condenser fans 144a, 144b can include “on state”, “off state”, “high speed state”, “low speed state” and “continuously varying speed state”. In some examples, the “on state” and “off state” command signals are employed where a single speed fan is used for each of the condenser fans 144a, 144b, “high speed state” and “low speed state” command signals are employed where a two speed fan is used for each of the condenser fans 144a, 144b, and “continuously varying speed state” commands are employed where a multi-speed fan is used for each of the condenser fans 144a, 144b.

The command signals for the desired state of the evaporator fan(s) 147 can likewise include “on state”, “off state”, “high speed state”, “low speed state” and “continuously varying speed state”. In some examples, the “on state” and “off state” command signals are employed where a single speed fan is used for the evaporator fan(s) 147, “high speed state” and “low speed state” command signals are employed where a two speed fan is used for the evaporator fan(s) 147 and “continuously varying speed state” command is employed where a multi-speed fan is used for the evaporator fan(s) 147.

Details of the various algorithms that can be stored in the memory will now be provided below.

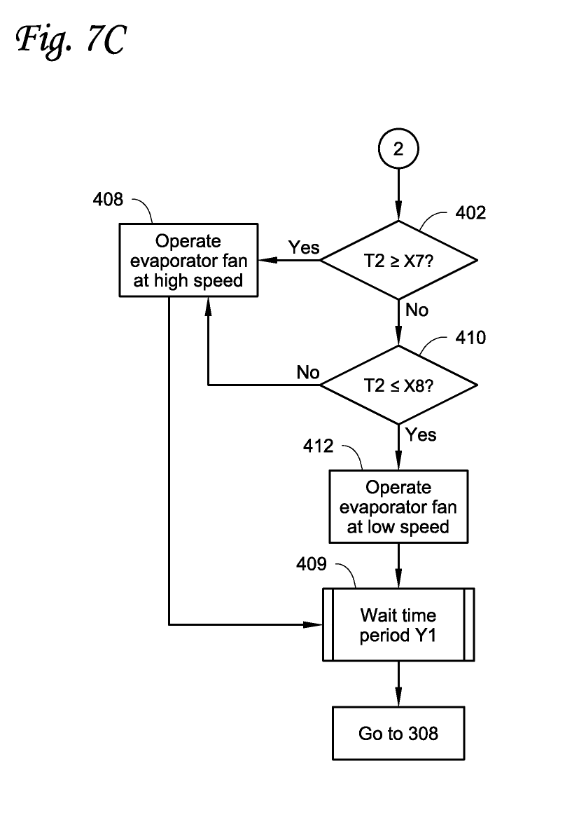

Generally, the TRS Controller 220 is configured to implement the disclosed process of controlling the operation of the condenser fans 144a, 144b and the evaporator fan 147 as illustrated in FIGS. 7A-7C. In general, the processes described in FIGS. 7A-7C are executed by the processor executing program instructions (algorithms) stored in the memory of the TRS Controller 220.

In some examples, the methods described herein involve determining one or more parameters and controlling a rate of heat rejection and/or a rate of heat absorption in the TRS 120 based on the determined parameters.

In some examples, the one or more parameters may be indicative of the status of the engine 208 and/or the status of the compressor 183. The status can include, for example, health, speed and/or vitals. The health can include power capacity such as residual power capacity, lubrication status, oil status, etc. The speed can be measured, for example, in units based on rpm. The vitals can include, for example, engine pressure, cooling temperature, available horse power, etc. The status of the engine 208 and/or the status of the compressor 183 can indicate, for example, normal operation, damage etc.

In some examples, the methods can generally involve determining an engine status, determining a compressor status, and then controlling a rate of heat rejection and/or a rate of heat absorption in the TRS 120 based on the determined statuses. In some examples, controlling the rate of heat rejection can involve controlling the condenser fans 144a, 144b. In some examples, controlling the rate of heat absorption can involve controlling the evaporator fan 147. In general, controlling the condenser fans 144a, 144b and/or the evaporator fan 147 lead to optimal temperature control of the TRS 120.

In some examples, the methods involves determining at least one parameter that is indicative of a status of the engine 208 and/or at least one parameter that is indicative of a status of the compressor 183 and controlling a rate of heat rejection and/or a rate of heat absorption of the TRS 120 based on the determined parameters.

FIGS. 7A-7C illustrate one embodiment of a process 300 for controlling the operation of the condenser fans 144a, 144b and the evaporator fan 147. At 305, the TRU 140 is started. The process 300 then proceeds to 308.

At 308, the TRS Controller 220 determines a discharge pressure temperature saturation (DPT_{SAT}), a minimum pressure temperature saturation (MPTSAT), a minimum discharge pressure (DP_{MIN}), an ambient temperature (AT); an engine coolant temperature (ECT), an engine intercooler temperature (EICT), an engine cooling fan request (ECFR), an engine intercooler fan request (EIFR) and a box temperature (BT) using the plurality of sensors 222.

In some examples, the TRS Controller 220 also determines the configuration of the TRS 120 and/or the operating mode of the TRS 120 (not shown). As described above, the TRS Controller 220 can receive as input data regarding certain TRS configurations of the TRS 120 and/or certain TRS operating modes of the TRS 120.

At 312, the TRS Controller 220 determines whether there is a conflict between the DPT_{SAT}, the MPT_{SAT}, the DP_{MIN}, the AT, the ECT, the EICT, the ECFR, the EIFR, the MOTI and the box temperature and predetermined operating conditions. Generally, the predetermined operating conditions prioritizes (1) prevention of damage to the power source 208, (2) cooling of the internal space 150, and (3) saving energy, in that order. In one example, a conflict occurs when the MOTI and the MPT_{SAT} are incompatible. In this instance, the MOTI takes priority over MPT_{SAT}. If there is a conflict, then the condenser fans 144a, 144b and the evaporator fan 147 operate based on the predetermined operating conditions at 322.

If there is no conflict, then the condenser fans 144a, 144b are turned on or off depending on certain conditions \textcircled{1} (details of the conditions \textcircled{1} are illustrated in FIG. 7B), and the evaporator fan 147 is operated at a high or low speed depending on certain conditions \textcircled{2} (details of the conditions \textcircled{2} are illustrated in FIG. 7C).

Details of the conditions \textcircled{1} will now be described with reference to FIG. 7B. At 331, the TRS Controller 220 determines if T1, which is the difference between the DPT_{SAT} and the AT, is greater than or equal to a first predetermined value (X1). In one example, X1 can be about 20° F. If T1 is greater than or equal to X1 at 331, then the condenser fan 144a is turned on at 338. The process then proceeds to 341, where the condenser fan 144a is turned on for a predetermined time period.

If T1 is not greater than or equal to X1 at 331, then the TRS Controller 220 determines if T1 is greater than or equal to a second predetermined value (X2) at 345. In one example, X2 can be about 15° F. If T1 is greater than or equal to X2 at 345, then the condenser fan 144b is turned on at 348. The process then proceeds to 341, where the condenser fan 144b is turned on for a predetermined time period.

If T1 is not greater than or equal to X2 at 345, then the TRS Controller 220 determines if the ECT is greater than or equal to a third predetermined value (X3) at 354. In one example, X3 can be about 200° F. If ECT is greater than or equal to X3 at 354, then the condenser fan 144a and/or the condenser fan 144b is(are) turned on at 362. The process then proceeds to 341, where the condenser fans 144a, 144b are turned on for a predetermined time period.

If the ECT is not greater than or equal to X3 at 354, then the TRS Controller 220 determines if the ECT is less than or equal to a fourth predetermined value (X4) at 365. In one example, X4 can be about 165° F. If the ECT is not less than or equal to X4 at 365, then the algorithm proceeds back to 308.

If the ECT is less than or equal to X4 at 365, then the TRS Controller 220 determines if T1 is less than a fifth predetermined value (X5) at 372. In one example, X5 can be about 1° F. If T1 is less than or equal to X5 at 372, then the condenser fan 144a is turned off at 378. The process then proceeds to 341, where the condenser fan 144a is turned off for a predetermined time period.

If T1 is not less than or equal to X5 at 372, then the TRS Controller 220 determines if T1 is less than a sixth predetermined value (X6) at 384. In one example, X6 can be about 3° F. If T1 is less than X6 at 384, then the condenser fan 144b is turned off at 395. The process then proceeds to 341, where the condenser fan 144b is turned off for a predetermined time period.

Details of the conditions \textcircled{2} will now be described with reference to FIG. 7C. At 402, the TRS Controller 220 determines if T2, which is the difference between the BT and a target temperature, is greater than or equal to a seventh predetermined value (X7). In one example, X7 can be about 10° F. If T2 is greater than or equal to X7 at 402, then the evaporator fan 137 is operated at high speed at 408. The process then proceeds to 409, where the evaporator fan 137 is operated at high speed for a predetermined time period, and then goes back to 308.

If T2 is not greater than or equal to X7, then the TRS Controller 220 determines if T2 is less than an eighth predetermined value (X8) at 410. In one example, X8 can be about 6° F. If T2 is not less than or equal to X8 at 410, then the evaporator fan 137 is operated at high speed at 408. The process 300 then proceeds to 409, where the evaporator fan 137 is operated at high speed for a predetermined time period, and then goes back to 308. If T2 is less than or equal to X8 at 410, then the evaporator fan 137 is operated at low speed at 412. The process 300 then proceeds to 409, where the evaporator fan 137 is operated at low speed for a predetermined time period, and then goes back to 308.

Note that in the above example illustrated in FIGS. 7A-7C, the condenser fans 144a, 144b are single speed fans that operate in either on or off states, and the evaporator fan 147 is a variable speed fan that operates in high speed or low speed. In some other examples, the condenser fans 144a, 144b can be variable speed fans and/or the evaporator fan 147 can be a single speed fan. In this instance, the algorithm described above would be similar to the process 300 except that the condenser fans 144a, 144b would operate, for example, at high speed or low speed rather than on or off states, respectively, and/or the evaporator fan 147 would operate at on or off states rather than high speed or low speed, respectively.

In some examples, the condenser fans 144a, 144b and the evaporator fan 147 can run on induction motors. In this instance, the condenser motor ON and OFF states are controlled to minimize the power used to move air through the condenser/radiator coils. The evaporator motor speed is controlled to optimize the power used to move air through the evaporator coil. The control algorithm can establish a balance between minimum power and sufficient air flow for temperature control purposes.

In some examples, the condenser fans 144a, 144b and the evaporator fan 147 can run on electronically commutated motors. In this instance, the condenser motor speed is controlled to minimize the power used to move air through the condenser/radiator coils. The evaporator motor speed is controlled to optimize the power used to move air through the evaporator coil. The control algorithm can establish a balance between minimum power and sufficient air flow for temperature control purposes.

In some embodiments, the TRS Controller 220 is further configured to provide controller instructions to drive single contactors at points 1-6 shown in FIG. 5.

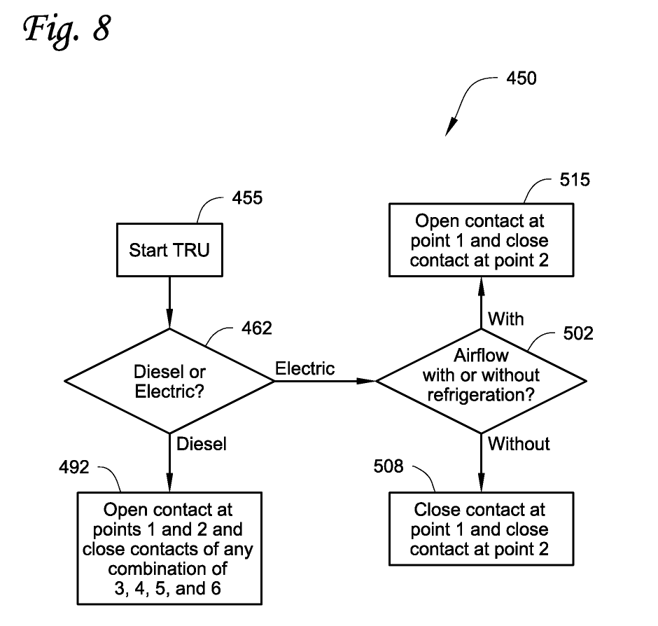

FIG. 8 illustrates one embodiment of a process 450 for providing controller instructions to drive single contactors at points 1-6 shown in FIG. 5. At 455, the TRU 140 is started. The process 450 then proceeds to 462.

At 462, the TRS Controller 220 determines the operating mode of the TRS 120. As discussed above, the inputs of the TRS Controller can include data regarding certain TRS operating modes. Data regarding the TRS operating mode can be whether the TRS is in a shore power mode or a genset power mode.

If the operating mode is determined to be the genset power mode, then contacts at points 1 and 2 are opened and the contacts of any combination of points 3, 4, 5 and 6 are closed at 492 so that airflow with refrigeration can be supplied to the internal space 150.

If the operating mode is determined to be the shore power mode, then a determination is made at 502 if airflow with refrigeration is to be supplied to the internal space 150. If airflow with refrigeration is to be supplied to the internal space 150, then contacts at points 1 and 2 are closed at 508.

If airflow without refrigeration is to be supplied to the internal space 150, then contact at point 1 is opened and the contact at point 2 is closed at 515.

In some other examples, the algorithm can drive multiple contacts in place of single contacts, for example, at points 3, 4 and 5. Multiple contacts can allow multiple motor speeds when, for example, an induction motor is used.

In some other examples, the algorithm can drive continuously variable speed motors by replacing contactor switching commands with Pulse Width Modulation or other types of variable control signals from the algorithm through the controller outputs.

In yet some other examples, the fan control algorithm can drive commands for condenser fan 144b using only refrigeration heat rejection requirements as input and/or engine intercooler and refrigeration heat rejection requirements as input.

In yet some other examples, the fan control algorithm can drive commands for condenser fan 144a using only refrigeration heat rejection requirements as input and/or engine cooling and refrigeration heat rejection requirements as input.

### Working Examples of Operating Conditions

The following Table I provides examples of operation conditions at different condenser fan speeds and evaporator fan speeds.

TABLE I

| | | | | | |
|---|---|---|---|---|---|
| | | | | | Motor |
| Engine RPM | VAC | Frequency (Hz) | Motor Pole | Fan RPM | HP |

EVAPORATOR

| | | | | | |
|---|---|---|---|---|---|
| ~2050 | ~345 | ~90 | ~6 | ~1800 | ~1.75 |
| ~1250 | ~210 | ~54.9 | ~4 | ~1646 | ~1.6 |
| ~1250 | ~210 | ~54.9 | ~6 | ~1098 | ~1.07 |

CONDENSER

| | | | | | |
|---|---|---|---|---|---|
| ~2050 | ~345 | ~90 | ~6 | ~1800 | ~0.75 |
| ~2050 | ~345 | ~90 | ~8 | ~1350 | ~0.32 |
| ~1250 | ~210 | ~54.9 | ~6 | ~1098 | ~0.46 |
| ~1250 | ~210 | ~54.9 | ~8 | ~824 | ~0.2 |

### Aspects:

Any one of aspects 1-14 can be combined with one another. Any one of aspects 15-20 can be combined with one another. Any one of aspects 1-14 can be combined with any one of aspects 15-20.

Aspect 1. A system, comprising:

a compressor;

an engine;

one or more sensors configured to detect at least one parameter that is indicative of a status of an engine and/or at least one parameter that is indicative of a status of a compressor, and

a controller that is configured to
(a) determine the at least one parameter that is indicative of the status of the engine and/or the at least one parameter that is indicative of the status of the compressor; and
(b) control a rate of heat rejection and/or a rate of heat absorption of the system based on (a).
   Aspect 2. The system of aspect 1, wherein the one or more sensors include a sensor to detect a discharge pressure temperature saturation (DPT_{SAT}), a sensor to detect a minimum pressure temperature saturation (MPT_{SAT}), a sensor to detect a minimum discharge pressure (DP_{MIN}), a sensor to detect an ambient temperature (AT), a sensor to detect an engine coolant temperature (ECT), a sensor to detect an engine intercooler temperature (EICT), a sensor to detect an engine cooling fan request (ECFR), a sensor to detect an engine intercooler fan request (EIFR) and/or a sensor to detect a box temperature (BT), and the at least one parameter that is indicative of a status of an engine and/or at least one parameter that is indicative of a status of a condenser includes DPT_{SAT}, the MPT_{SAT}, the DP_{MIN}, the AT, the ECT, the EICT, the ECFR, the EIFR, a Fan Minimum OFF Time (MOTI) and/or the BT.
   Aspect 3. The system of any of aspects 1-2, wherein when the sensors are configured to detect at least two parameters, the controller is further configured to determine when there is conflict between the parameters determined in (a).
   Aspect 4. The system of aspect 3, wherein the system further comprises first and second condenser fans and an evaporator fan, and wherein the controller is further configured to operate the first condenser fan, the second condenser fan and the evaporator fan based on predetermined operating conditions when there is a conflict in (a).
   Aspect 5. The system of aspect 2, wherein the system further comprises first and second condenser fans, and wherein the controller is further configured to operate the first and/or the second condenser fan(s) in a first or second state based on the following conditions:
(c1) if T1 is greater than a first predetermined value, then operate the first condenser fan in the first state, wherein T1 is the difference between the DPT_{SAT} and the AT determined (a);
(c2) if T1 is greater than a second predetermined value, then operate the second condenser fan in the first state;
(c3) if the ECT determined in (a) is greater than a third predetermined value, then operate the first condenser fan and the second condenser fan in the first state;
(c4) if T1 is less than a fourth predetermined value and the ECT determined in (a) is less than a fifth predetermined value, then operate the first condenser in the second state;
(c5) if T1 is less than a sixth predetermine value and the ECT determined in (a) is less than the fifth predetermined value, then turn the second condenser fan off.
   Aspect 6. The system of aspect 5, wherein the system further comprises an evaporator fan, and wherein the controller is further configured to operate the evaporator fan the evaporator fan is a operated in a third or fourth state based on the following conditions:
(c6) if T2 is greater than a seventh predetermined value, then operate the evaporator fan in the third state, wherein T2 is the difference between the BT and a target temperature;
(c7) if T2 is less than an eighth predetermined value, then operate the evaporator fan in the fourth state;
   Aspect 7. The system of any of aspects 1-6, further comprising an intercooler.
   Aspect 8. The system of aspect 6, wherein each of the first, second, third and fourth states is at least one selected from the group consisting of an on state, an off state, a high speed state, a low speed state and a continuously varying speed state.
   Aspect 9. The system of any of aspects 6 and 8, wherein the first and second states are different from one another, and the third and fourth states are different from one another.
   Aspect 10. The system of any of aspects 5, 6, 8 and 9, wherein the first condenser fan is on a curb side, and the second condenser fan is on a road side.
   Aspect 11. The system of any of aspects 5, 6, and 8-10, wherein the first and second condenser fans are single speed fans.
   Aspect 12. The system of any of aspects 6, and 8-11 wherein the evaporator fan is a variable speed fan.
   Aspect 13. The system of aspect 3, wherein in (b), a conflict occurs when the MOTI and the MPT_{SAT} are incompatible.
   Aspect 14. The system of aspect 13, wherein the MOTI takes priority over MPT_{SAT}.
   Aspect 15. The system of any of aspects 1-14, wherein the system further comprises one or more condenser fans and an evaporator fan, and wherein the controlling the rate of heat rejection and/or the rate of heat absorption of the system involves controlling the one or more condenser fans and/or the evaporator fan.
   Aspect 16. A method of controlling a system that includes an engine and a compressor, comprising:
(a) determining at least one parameter that is indicative of a status of an engine and/or at least one parameter that is indicative of a status of a compressor; and
(b) controlling a rate of heat rejection and/or a rate of heat absorption of the system based on (a).
   Aspect 17. The method of aspect 16, wherein the at least one parameter that is indicative of a status of an engine and/or the at least one parameter that is indicative of a status of a condenser include a discharge pressure temperature saturation (DPT_{SAT}), a minimum pressure temperature saturation (MPT_{SAT}), a minimum discharge pressure (DP_{MIN}), an ambient temperature (AT), an engine coolant temperature (ECT), an engine intercooler temperature (EICT), an engine cooling fan request (ECFR), an engine intercooler fan request (EIFR) and/or a box temperature (BT).
   Aspect 18. The method of any of aspects 16-17, further comprising determining if there is conflict between the parameters determined in (a).
   Aspect 19. The method of aspect 18, wherein the system further comprises first and second condenser fans and an evaporator fan, and the method further comprises operating the first condenser fan, the second condenser fan and the evaporator fan based on predetermined operating conditions if there is a conflict in (a).
   Aspect 20. The method of any of aspects 16-19, wherein the system further comprises first and second condenser fans, and the method further comprises operating the first and/or the second condenser fan(s) in a first or second state based on the following conditions:

(c1) if T1 is greater than a first predetermined value, then operate the first condenser fan in the first state, wherein T1 is the difference between the DPT_{SAT} and the AT determined (a);
(c2) if T1 is greater than a second predetermined value, then operate the second condenser fan in the first state;
(c3) if the ECT determined in (a) is greater than a third predetermined value, then operate the first condenser fan and the second condenser fan in the first state;
(c4) if T1 is less than a fourth predetermined value and the ECT determined in (a) is less than a fifth predetermined value, then operate the first condenser in the second state;
(c5) if T1 is less than a sixth predetermine value and the ECT determined in (a) is less than the fifth predetermined value, then turn the second condenser fan off.
   Aspect 21. The method of any of aspects 16-20, wherein the system further comprises an evaporator fan, and wherein the method further comprises operating the evaporator fan the evaporator fan in a third or fourth state based on the following conditions:
(c6) if T2 is greater than a seventh predetermined value, then operate the evaporator fan in the third state, wherein T2 is the difference between the BT and a target temperature;
(c7) if T2 is less than an eighth predetermined value, then operate the evaporator fan in the fourth state.
   Aspect 22. The method of any of aspects 16-21, wherein the system further comprises one or more condenser fans and an evaporator fan, and wherein the controlling the rate of heat rejection and/or the rate of heat absorption of the system involves controlling the one or more condenser fans and/or the evaporator fan.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

1. A system, comprising:
a compressor;
an engine;
one or more sensors configured to detect at least one parameter that is indicative of a status of an engine and/or at least one parameter that is indicative of a status of a compressor, and
a controller that is configured to
(a) determine the at least one parameter that is indicative of the status of the engine and/or the at least one parameter that is indicative of the status of the compressor; and
(b) control a rate of heat rejection and/or a rate of heat absorption of the system based on (a),
wherein when the sensors are configured to detect at least two parameters, the controller is further configured to determine when there is conflict between the parameters determined in (a).

2. The system of claim 1, wherein the one or more sensors include a sensor to detect a discharge pressure temperature saturation (DPT_{SAT}), a sensor to detect a minimum pressure temperature saturation (MPT_{SAT}), a sensor to detect a minimum discharge pressure (DP_{MIN}), a sensor to detect an ambient temperature (AT), a sensor to detect an engine coolant temperature (ECT), a sensor to detect an engine intercooler temperature (EICT), a sensor to detect an engine cooling fan request (ECFR), a sensor to detect an engine intercooler fan request (EIFR) and/or a sensor to detect a box temperature (BT), and the at least one parameter that is indicative of a status of an engine and/or at least one parameter that is indicative of a status of a condenser includes DPT_{SAT}, the MPT_{SAT}, the DP_{MIN}, the AT, the ECT, the EICT, the ECFR, the EIFR, a Fan Minimum OFF Time (MOTI) and/or the BT.

3. (canceled)

4. The system of claim 1, wherein the system further comprises first and second condenser fans and an evaporator fan, and wherein the controller is further configured to operate the first condenser fan, the second condenser fan and the evaporator fan based on predetermined operating conditions when there is a conflict in (a).

5. The system of claim 2, wherein the system further comprises first and second condenser fans, and wherein the controller is further configured to operate the first and/or the second condenser fan(s) in a first or second state based on the following conditions:
(c1) if T1 is greater than a first predetermined value, then operate the first condenser fan in the first state, wherein T1 is the difference between the DPT_{SAT} and the AT determined (a);
(c2) if T1 is greater than a second predetermined value, then operate the second condenser fan in the first state;
(c3) if the ECT determined in (a) is greater than a third predetermined value, then operate the first condenser fan and the second condenser fan in the first state;
(c4) if T1 is less than a fourth predetermined value and the ECT determined in (a) is less than a fifth predetermined value, then operate the first condenser in the second state;
(c5) if T1 is less than a sixth predetermine value and the ECT determined in (a) is less than the fifth predetermined value, then turn the second condenser fan off.

6. The system of claim 5, wherein the system further comprises an evaporator fan, and wherein the controller is further configured to operate the evaporator fan the evaporator fan is a operated in a third or fourth state based on the following conditions:
(c6) if T2 is greater than a seventh predetermined value, then operate the evaporator fan in the third state, wherein T2 is the difference between the BT and a target temperature;
(c7) if T2 is less than an eighth predetermined value, then operate the evaporator fan in the fourth state;

7. The system of claim 1, further comprising an intercooler.

8. The system of claim 6, wherein each of the first, second, third and fourth states is at least one selected from the group consisting of an on state, an off state, a high speed state, a low speed state and a continuously varying speed state.

9. The system of claim 6, wherein the first and second states are different from one another, and the third and fourth states are different from one another.

10. The system of claim 5, wherein the first condenser fan is on a curb side, and the second condenser fan is on a road side.

11. The system of claim 5, wherein the first and second condenser fans are single speed fans.

12. The system of claim 6, wherein the evaporator fan is a variable speed fan.

13. The system of claim 1, wherein in (b), a conflict occurs when the MOTI and the MPT_{SAT} are incompatible.

14. The system of claim 13, wherein the MOTI takes priority over MPT_{SAT}.

15. The system of claim 1, wherein the system further comprises one or more condenser fans and an evaporator fan, and wherein the controlling the rate of heat rejection and/or the rate of heat absorption of the system involves controlling the one or more condenser fans and/or the evaporator fan.

16. A method of controlling a system that includes an engine and a compressor, comprising:
(a) determining at least one parameter that is indicative of a status of an engine and/or at least one parameter that is indicative of a status of a compressor;
(b) controlling a rate of heat rejection and/or a rate of heat absorption of the system based on (a); and
(c) determining if there is a conflict between the parameters determined in (a).

17. The method of claim 16, wherein the at least one parameter that is indicative of a status of an engine and/or the at least one parameter that is indicative of a status of a condenser include a discharge pressure temperature saturation (DPT_{SAT}), a minimum pressure temperature saturation (MPT_{SAT}), a minimum discharge pressure (DP_{MIN}), an ambient temperature (AT), an engine coolant temperature (ECT), an engine intercooler temperature (EICT), an engine cooling fan request (ECFR), an engine intercooler fan request (EIFR) and/or a box temperature (BT).

18. (canceled)

19. The method of claim 16, wherein the system further comprises first and second condenser fans and an evaporator fan, and the method further comprises operating the first condenser fan, the second condenser fan and the evaporator fan based on predetermined operating conditions if there is a conflict in (a).

20. The method of claim 16, wherein the system further comprises first and second condenser fans, and the method further comprises operating the first and/or the second condenser fan(s) in a first or second state based on the following conditions:
(c1) if T1 is greater than a first predetermined value, then operate the first condenser fan in the first state, wherein T1 is the difference between the DPT_{SAT} and the AT determined (a);
(c2) if T1 is greater than a second predetermined value, then operate the second condenser fan in the first state;
(c3) if the ECT determined in (a) is greater than a third predetermined value, then operate the first condenser fan and the second condenser fan in the first state;
(c4) if T1 is less than a fourth predetermined value and the ECT determined in (a) is less than a fifth predetermined value, then operate the first condenser in the second state;
(c5) if T1 is less than a sixth predetermine value and the ECT determined in (a) is less than the fifth predetermined value, then turn the second condenser fan off.

21. A method of controlling a system that includes an engine and a compressor, comprising:
(a) determining at least one parameter that is indicative of a status of an engine and/or at least one parameter that is indicative of a status of a compressor; and
(b) controlling a rate of heat rejection and/or a rate of heat absorption of the system based on (a) wherein the system further comprises an evaporator fan,
wherein the method further comprises operating the evaporator fan the evaporator fan in a third or fourth state based on the following conditions:
(c6) if T2 is greater than a seventh predetermined value, then operate the evaporator fan in the third state, wherein T2 is the difference between the BT and a target temperature;
(c7) if T2 is less than an eighth predetermined value, then operate the evaporator fan in the fourth state.

22. The method of claim 16, wherein the system further comprises one or more condenser fans and an evaporator fan, and wherein the controlling the rate of heat rejection and/or the rate of heat absorption of the system involves controlling the one or more condenser fans and/or the evaporator fan.
